(19) United States
(12) Patent Application Publication
(10) Pub. No.: US 2025/0309413 A1
(43) Pub. Date: Oct. 2, 2025

(54) RECHARGEABLE BATTERY

(71) Applicant: Samsung SDI Co., Ltd., Yongin-si (KR)

(72) Inventors: Dae Kyu Kim, Yongin-si (KR); Mirae Im, Yongin-si (KR)

(73) Assignee: Samsung SDI Co., Ltd., Yongin-si (KR)

(21) Appl. No.: 18/970,352

(22) Filed: Dec. 5, 2024

(30) Foreign Application Priority Data
Mar. 26, 2024 (KR) 10-2024-0041226

(51) Int. Cl. H01M 50/107; H01M 10/04; H01M 50/119; H01M 50/152

(52) U.S. Cl. CPC H01M 50/107; H01M 10/0431; H01M 50/119; H01M 50/152

(57) ABSTRACT

A rechargeable battery includes an electrode assembly, a can that accommodates the electrode assembly in the inner (interior) space, and a cap plate that is coupled to the opening side end of the can and seals the can. The can includes a main can and a reinforcing portion. The main can includes a bottom portion with a first thickness and a side portion that is connected to the edge of the bottom portion and has a second thickness smaller than the first thickness. The reinforcing portion is positioned inside the side portion. The reinforcing portion has a third thickness less than the second thickness and a strength greater than a strength of the main can. The sum of the second thickness and the third thickness is less than the first thickness.

### CROSS-REFERENCE TO RELATED APPLICATIONS

This present application claims priority to and the benefit under 35 U.S.C. § 119(a)-(d) of Korean Patent Application No. 10-2024-0041226, filed on Mar. 26, 2024, in the Korean Intellectual Property Office, the entire disclosure of which is incorporated herein by reference.

### FIELD

The present disclosure relates to a rechargeable battery. More particularly, the present disclosure relates to a structure of a can that accommodates an electrode assembly.

### BACKGROUND

Rechargeable batteries are used for various purposes, including powering small electronic devices such as mobile phones and laptop computers, and powering motors for transportation vehicles such as electric vehicles and hybrid vehicles. Rechargeable batteries may be classified into cylindrical, prismatic, pouch-type, etc. depending on the appearance thereof, and cylindrical and prismatic rechargeable batteries include a can made of metal.

The cans may be manufactured to have a bottom portion and a side portion through a typical deep drawing process, and a cap plate is attached to the opening side end of the can to seal the can. Smaller thicknesses of the can are generally more advantageous for increasing the capacity of the electrode assembly and dissipating heat generated from the electrode assembly to the outside, but reducing the thickness may lower the mechanical strength of the can.

### SUMMARY

The present disclosure seeks to provide a rechargeable battery that may achieve reduced thickness without degrading the mechanical strength of the can.

A rechargeable battery includes an electrode assembly, a can that accommodates the electrode assembly in an interior space of the can, and a cap plate that is coupled to an opening side end of the can and seals the can. The can includes a main can and a reinforcing portion. The main can includes a bottom portion with a first thickness and a side portion, having second thickness smaller than the first thickness, connected to the edge of the bottom portion. The reinforcing portion is positioned inside the side portion. The reinforcing portion has a third thickness less than the second thickness, and a strength greater than a strength of the main can. The sum of the second thickness and the third thickness is less than the first thickness.

The reinforcing portion may be in the form of a cylinder, and the exterior diameter of the reinforcing portion may correspond to a value of the interior diameter of the side portion plus a fitting allowance. The reinforcing portion may be formed of an approximate cylinder shape that implements elasticity along the circumferential direction, and may be in close contact with the inner surface of the side portion.

The reinforcing portion may have a first end and a second end that are spaced apart from each other along a circumferential direction of the reinforcing portion, and may be formed in a circular arc or a “C” shape on a plane. In some embodiments, the reinforcing portion may include a first end and a second end, and the reinforcing portion may have a circumferential direction length exceeding 1 rotation from the first end to the second end, such that the reinforcing portion may overlap between the first end and the second end.

The side portion may include a beading portion recessed toward the interior of the can. The reinforcing portion may be positioned between the bottom portion and the beading portion. The beading portion may be connected to the side portion through a first curved portion of the beading portion, and the side portion may be connected to the bottom portion through a second curved portion. The reinforcing portion may be positioned between the first curved portion and the second curved portion.

The electrode assembly may include a central portion where a first electrode, a separator, and a second electrode are stacked and wound, a first uncoated region positioned on one side of the central portion toward the bottom portion, and a second uncoated region positioned on the other side of the central portion toward the cap plate. The height of the reinforcing portion may be equal to the height of the central portion, and the reinforcing portion may be positioned to surround the central portion.

The main can may be formed of a cold rolled steel plate (SPCE) deep-drawn extra for a deep processing, and the reinforcing portion may be formed of a stainless steel, a steel plate cold commercial (SPCC), and/or a high-strength steel. The second thickness may be 0.15 mm to 0.4 mm, and the third thickness may be 0.05 mm to 0.3 mm.

A rechargeable battery according to some embodiments includes an electrode assembly, a can that accommodates the electrode assembly in an interior space of the can, and a cap plate that is coupled to an opening side end of the can and seals the can. The can includes a bottom portion made of a single material and a tubular portion connected to the edge of the bottom portion. The tubular portion has a thickness smaller than that of the bottom portion, and comprises an outer part and an inner part with different materials and thicknesses.

The outer part may be made of the same material as the bottom portion, and the outer part and the bottom portion may be integrally connected. The inner part may be formed of a material with a greater strength than the strength of the bottom portion and the outer part, and the thickness of the inner part may be smaller than the thickness of the outer part. The outer part may include a beading portion recessed toward the interior of the can. The inner part may be positioned between the bottom portion and the beading portion.

The inner part may be in the form of a cylinder, and the exterior diameter of the inner part may correspond to a value of the interior diameter of the outer part plus a fitting allowance. The inner part may have a first end and a second end that are spaced apart from each other along the circumferential direction of the tubular portion, and may be formed of a circular arc or a “C” shape on a plane. In some embodiments, the inner part may include a first end and a second end, and may have a circumferential direction length exceeding 1 rotation from the first end to the second end, such that the inner part may overlap between the first end and the second end.

The rechargeable battery according to embodiments may increase the capacity of the electrode assembly by slimming the tubular portion of the can, and may prevent the strength deterioration due to the slimming of the tubular portion by using the reinforcing portion. Additionally, since the reinforcing portion and the side portion do not require separate junction processes such as welding or bonding, a can manufacturing process may be simplified.

Certain aspects of the present disclosure generally relate to a method for manufacturing a rechargeable battery. In some embodiments, the method comprises positioning an electrode assembly in an interior space of a can, wherein: a cap plate is coupled to an opening side end of the can; the cap plate seals the can; the can includes a bottom portion made of a single material; and the can includes a tubular portion that is connected to the edge of the bottom portion, the tubular portion having a thickness smaller than the thickness of the bottom portion and comprising of an outer part and an inner part with different materials and thicknesses.

In some embodiments, the outer part is made of the same material as the bottom portion, and the outer part and the bottom portion are integrally connected.

In some embodiments, the inner part is formed of a material with greater strength than the strength of the bottom portion and the outer part, and the thickness of the inner part is smaller than the thickness of the outer part.

### BRIEF DESCRIPTION OF THE DRAWINGS

FIG. 1 is a perspective view of a rechargeable battery according to some embodiments.

FIG. 2 is a cross-sectional view of a rechargeable battery shown in FIG. 1, according to some embodiments.

FIG. 3 is a partial enlarged view of an electrode assembly of a rechargeable battery shown in FIG. 2, according to some embodiments.

FIG. 4 is a schematic diagram showing a part of a manufacturing process of a can of a rechargeable battery shown in FIG. 1, according to some embodiments.

FIG. 5 is a cross-sectional view showing a can of a rechargeable battery shown in FIG. 2, according to some embodiments.

FIG. 6 and FIG. 7 are partial enlarged views of FIG. 5, according to some embodiments.

FIG. 8 is a cross-sectional view of a can of a rechargeable battery according to a second embodiment, according to some embodiments.

FIG. 9 is a perspective view of a reinforcing portion of a can shown in FIG. 8, according to some embodiments.

FIG. 10 is a cross-sectional view of a can of a rechargeable battery according to a third embodiment, according to some embodiments.

FIG. 11 is a perspective view of a reinforcing portion of a can shown in FIG. 10, according to some embodiments.

FIG. 12 is a cross-sectional view of a rechargeable battery according to a fourth embodiment, according to some embodiments.

### DETAILED DESCRIPTION

Hereinafter, the present invention will be described more fully with reference to the accompanying drawings, in which embodiments of the invention are shown. As those skilled in the art would realize, the described embodiments may be modified in various different ways, all without departing from the spirit or scope of the present invention.

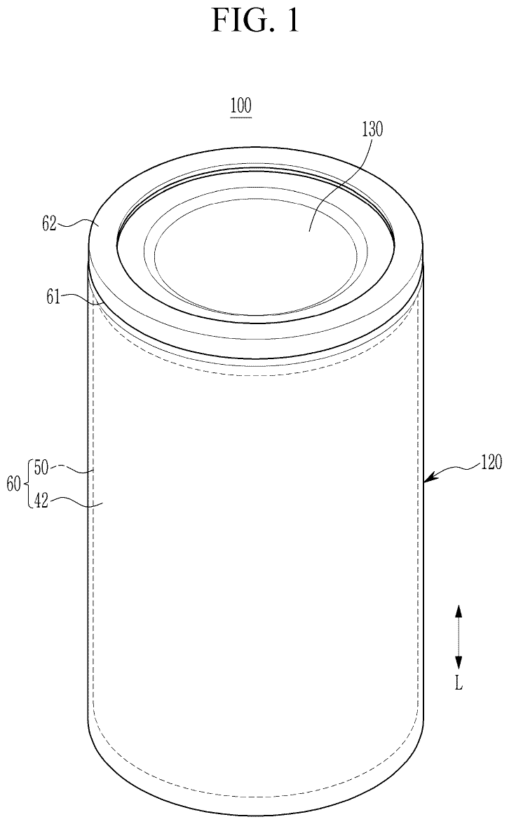

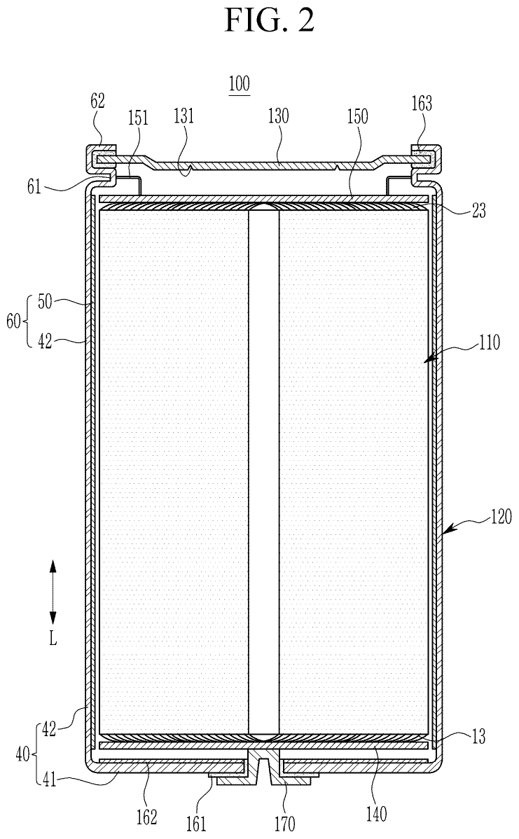

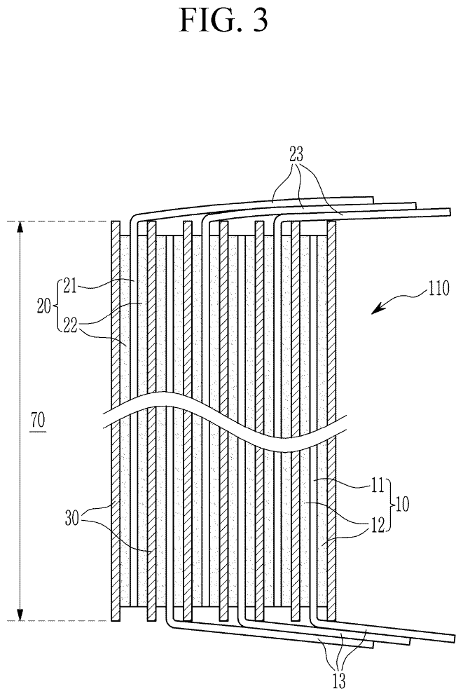

FIG. 1 is a perspective view of a rechargeable battery according to the first embodiment. FIG. 2 is a cross-sectional view of a rechargeable battery shown in FIG. 1. FIG. 3 is a partial enlarged view of an electrode assembly of a rechargeable battery shown in FIG. 2.

Referring to FIG. 1 to FIG. 3, a rechargeable battery 100 of the present embodiment may include an electrode assembly 110, a can 120 that accommodates the electrode assembly 110 in the inner (e.g., interior) space, and a cap plate 130 that is coupled to the opening side end of the can 120 and seals the can 120. The can 120 may have a dual structure of a main can 40 and a reinforcing portion 50 made of different materials.

The electrode assembly 110 may include a first electrode 10, a second electrode 20, and a separator 30. The electrode assembly 110 may be configured as a wound type in which a band-shaped stack is wound in a jelly roll shape. The stack may be a sequentially stacked configuration of the first electrode 10, the separator 30, the second electrode 20, and the separator 30, and may be wound multiple times around a center pin. In the stack, the positions of the first electrode 10 and the second electrode 20 may be switched.

The first electrode 10 may include a first substrate 11 and a first composite layer 12 positioned on the first substrate 11. The first composite layer 12 may be positioned on the remaining portion of the first substrate 11 except for one (e.g., lower) edge. Among the first substrate 11, the part where the surface is exposed without being covered with the first composite layer 12 may be referred to as a first uncoated region 13.

The second electrode 20 may include a second substrate 21 and a second composite layer 22 positioned on the second substrate 21. The second composite layer 22 may be positioned on the remaining portion of the second substrate 21 except for the other (e.g., upper) edge. Among the second substrate 21, the part where the surface is exposed without being covered with the second composite layer 22 may be referred to as a second uncoated region 23.

In a lithium ion rechargeable battery, the first substrate 11 may be composed of an aluminum foil, and the first composite layer 12 may include a transition metal oxide such as LiCoO₂, LiNiO₂, LiMn₂O₄, Li(NiCoAl)O₂, LiFePO₄, Li(NiCoMn)O₂, a conductive material, and/or a binder. The second substrate 21 may be composed of a copper foil and/or a nickel foil, and the second composite layer 22 may include graphite, a conductive material, and/or a binder. The first electrode 10 may be referred to as a positive electrode, and the second electrode 20 may be referred to as a negative electrode.

The separator 30 may be composed of a porous substrate, or may be composed of a porous substrate with a coating layer positioned on at least one side. The porous substrate may include at least one of polyethylene, polypropylene, polyethylene terephthalate, polypropylene terephthalate, polybutylene terephthalate, polyester, polycarbonate, and/or polyimide. The coating layer may include a binder, and the binder may include a polyvinylidene fluoride-based compound. The separator 30 may insulate the first electrode 10 and the second electrode 20 while allowing movement of lithium ions.

The first uncoated region 13 may be bent toward the wound center of the electrode assembly 120 and overlap the first uncoated region 13 positioned inside. The second uncoated region 23 may also be bent toward the wound center of the electrode assembly 120 and overlap the second uncoated region 23 positioned inside. In some embodiments, incision lines are positioned in each of the first and second uncoated regions 13 and 23 to facilitate the bending of the first and second uncoated regions 13 and 23.

A first current collecting plate 140 may be positioned on the outer side (e.g., the lower side) of the first uncoated region 13, and the first current collecting plate 140 may be affixed to the first uncoated region 13 by a method such as laser welding. A second current collecting plate 150 may be positioned on the outer side (e.g., the upper side) of the second uncoated region 23, and the second current collecting plate 150 may be affixed to the second uncoated region 23 by a method such as laser welding. The electrode assembly 110 and the first and second current collecting plates 140 and 150 may be accommodated in the inner (interior) space of the can 120 together with an electrolyte solution.

The can 120 has a shape in which one side (e.g., the upper side) is opened so that the electrode assembly 110, and the first and second current collecting plates 140 and 150 may be inserted. The can 120 may include the main can 40 including a bottom portion 41 and a side portion 42 integrally connected, and a reinforcing portion 50 made of a metal material different from the main can 40. In some embodiments, the bottom portion 41 may be referred to as a top portion when the top and bottom of the rechargeable battery 100 are changed (e.g., when inverted).

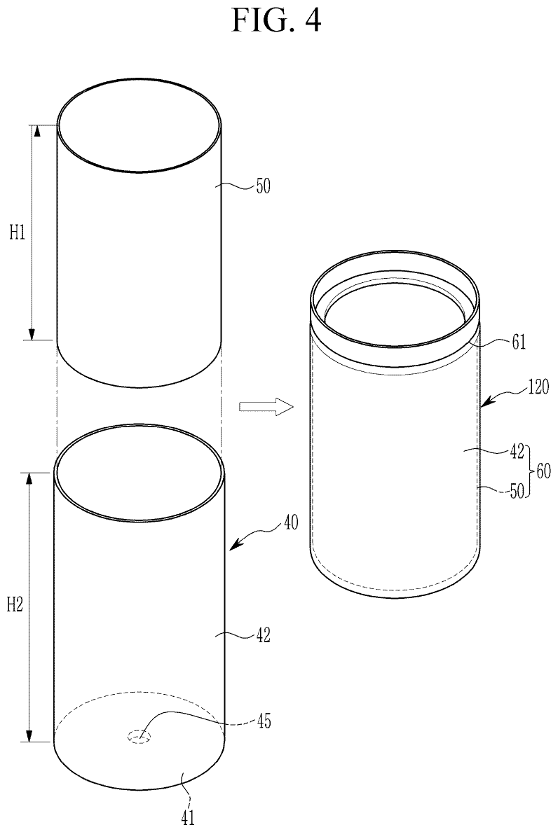

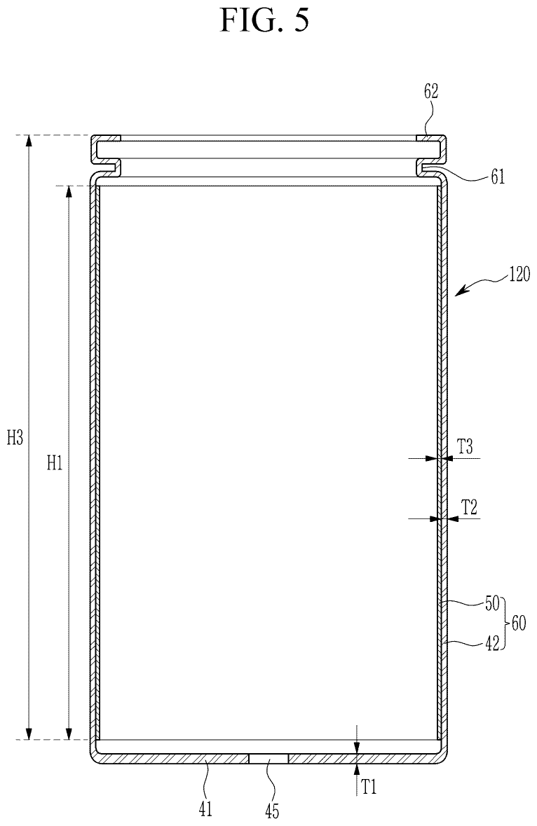

FIG. 4 is a schematic diagram showing a part of a manufacturing process of a can among a rechargeable battery shown in FIG. 1. FIG. 5 is a cross-sectional view showing a can of a rechargeable battery shown in FIG. 2.

Referring to FIG. 4 and FIG. 5, the can 120 may include the main can 40 which includes the bottom portion 41 and the side portion 42 which are integrally connected, and the reinforcing portion 50 which is positioned inside the side portion 42 and is made of a metal material with greater strength than the main can 40. In some embodiments, the thickness of the side portion 42 may be smaller than the thickness of the bottom portion 41, the thickness of the reinforcing portion 50 may be smaller than the thickness of the side portion 42, and the sum of the thicknesses of the side portion 42 and the reinforcing portion 50 may be smaller than the thickness of the bottom portion 41.

The main can 40 may be manufactured to have the bottom portion 41 and the side portion 42 by a normal deep drawing process. The bottom portion 41 has a first thickness (T1, referring to FIG. 5), and the side portion 42 has a second thickness (T2, referring to FIG. 5) that is smaller than the first thickness T1. For example, a metal base material consisting of a central portion with the first thickness T1 and a peripheral portion with the second thickness T2 may be prepared, and the boundary between the central portion and the peripheral portion may be vertically bent by a deep drawing process of the metal base material. Through this process, according to some embodiments, the main can 40 may be produced.

The reinforcing portion 50 may be composed of a cylinder shape with a constant interior diameter and an exterior diameter, and may enter the inside of the main can 40 and be positioned inside the side portion 42. The reinforcing portion 50 may overlap the side portion 42, and forms a tubular portion 60 of the can 120 with the side portion 42, thereby forming the tubular portion 60 of the can 120 in a double structure. That is, in the some embodiments, the can 120 may consist of the bottom portion 41 made of a single material and the tubular portion 60 made of heterogeneous materials with different thicknesses and materials. The side portion 42 of the main can 40 may be referred to as an outer part of the tubular portion 60, and the reinforcing portion 50 may be referred to as an inner part of the tubular portion 60.

The reinforcing portion 50 may have a third thickness (T3, referring to FIG. 5) that is smaller than a second thickness T2, and the sum of the second thickness T2 and a third thickness T3 may be smaller than the first thickness T1. The height of the reinforcing portion 50 (H1, referring to FIG. 5) may be smaller than the heights H2 and H3 of the side portion 42. In FIG. 4, the height of the side portion 42 indicated by H2 is the height of the side portion 42 before processing of a beading portion 61 and a crimping portion 62, to be described below.

The reinforcing portion 50 may be positioned on the inside of the side portion 42 to be closer to the bottom portion 41 than to the opening side (e.g., the upper side) end of the side portion 42. In other words, in some embodiments, a part of the upper side of the side portion 42 does not overlap the reinforcing portion 50 and the side portion 42 may exist alone.

The reinforcing portion 50 may be made of a metal with relatively higher strength than the main can 40. In some embodiments, strength refers to a yield strength or a tensile strength when comparing the metal material of the reinforcing portion and the metal material of the main can having the same thickness. For example, according to some embodiments, the main can 40 may be made of a steel plate cold deep-drawn extra (SPCE) for a deep processing, and the reinforcing portion 50 may be made of stainless steel, a steel plate cold commercial (SPCC), and/or a high-strength steel, etc.

The tensile strength of the SPCE and the SPCC is over 270 N/mm². Among stainless steels, the tensile strength of austenitic steel is over 480 N/mm², that of ferritic steel is over 360 N/mm², and that of martensitic steel is over 520 N/mm². Among high-strength steels, the tensile strength of KS carbon steel is over 400 N/mm². When manufacturing the reinforcing portion 50, SPCC, which has higher tensile strength than SPCE, may be selected and used as the reinforcing portion 50.

The reinforcing portion 50 may be positioned in contact with the inner surface of the side portion 42 of the main can 40 without being joined to it by welding or bonding. To allow the reinforcing portion 50 to enter the inside of the main can 40, the exterior diameter of the reinforcing portion 50, according to some embodiments, may correspond to a value of the interior diameter of the side portion 42 plus a predetermined fitting allowance. In some embodiments, the reinforcing portion 50 does not have a junction surface between the side portion 42, and the fitting allowance allows some regions of the reinforcing portion 50 to be in close contact with the side portion 42 and to be positioned with a predetermined gap from the side portion 42 in other areas.

After the reinforcing portion 50 enters the inside of the main can 40, the electrode assembly 110 to which the first and second current collecting plates 140 and 150 are affixed may be accommodated inside the can 120. Thereafter, the side portion 42 may be molded to have the beading portion 61 through a normal press processing. The beading portion 61 is a recessed portion toward the inside of the can 120 and functions to suppress the motion of the electrode assembly 110. The beading portion 61 may be positioned on a portion of the opening side (e.g., the upper side) of the side portion 42 that does not overlap the reinforcing portion 50.

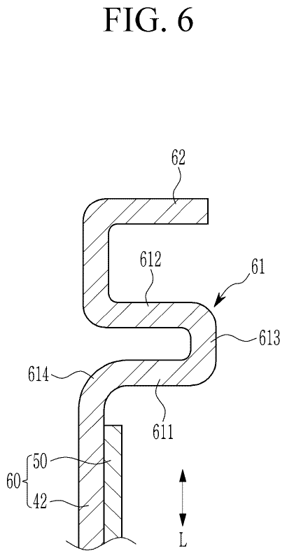

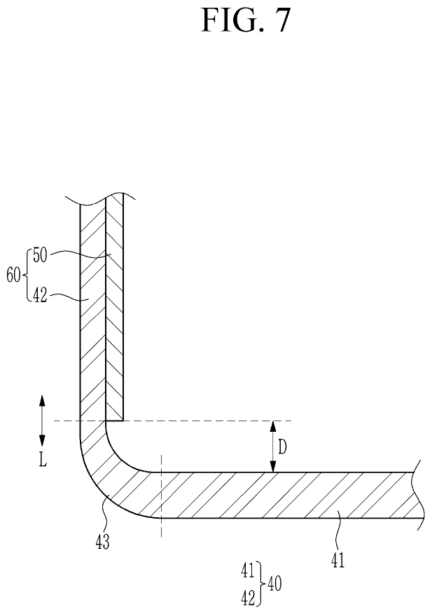

FIG. 6 and FIG. 7 are partial enlarged views of FIG. 5.

Referring to FIG. 6 and FIG. 7, the beading portion 61 may include a first horizontal portion 611 and a second horizontal portion 612, and a vertical portion 613 connecting the first horizontal portion 611 and the second horizontal portion 612. The first horizontal portion 611 may be connected to the side portion 42 through a first curved portion 614. The reinforcing portion 50 may be positioned under and/or proximate to the beading portion 61 along the length direction (the direction L) of the can 120 so as not to overlap the beading portion 61, and may be specifically positioned under and/or proximate to the first curved portion 614.

Since the reinforcing portion 50 is made of metal material with higher strength than the main can 40, assuming that the reinforcing portion 50 overlaps the beading portion 61, the workability of the beading portion 61 may deteriorate and the molding quality of the beading portion 61 may be lowered. The beading portion 61 is provided in the upper region of the side portion 42 which does not overlap the reinforcing portion 50, thereby facilitating press processing and improving molding quality.

The side portion 42 and the bottom portion 41 of the main can 40 may be connected through the second curved portion 43, and the reinforcing portion 50 may be positioned on the upper side of the second curved portion 43 along the length direction (the direction L) of the can 120. The reinforcing portion 50 may be positioned higher than and/or proximate to the bottom portion 41 with a distance corresponding to the height of the second curved portion 43 from the inner surface (e.g., the upper surface) of the bottom portion 41. For example, according to some embodiments, the distance D between the inner surface (e.g., the upper surface) of the bottom portion 41 and the reinforcing portion 50 may be approximately 0.05 mm or more. The reinforcing portion 50 may be positioned between the first curved portion 614 and the second curved portion 43 on the inside of the side portion 42.

Referring to FIG. 2 and FIG. 4, a terminal hole 45 may be positioned in the center of the bottom portion 41, and a rivet terminal 170 may be installed in the terminal hole 45 through a first insulator 161. The first insulator 161 may insulate the bottom portion 41 and the rivet terminal 170, and seals the terminal hole 45 to prevent leakage of the electrolyte solution.

The rivet terminal 170 may be connected to the first current collecting plate 140 and may be charged with the same polarity as the first electrode 10, and may function as a first terminal (a positive terminal). At this time, a second insulator 162 may be positioned between the bottom portion 41 and the first current collecting plate 140 to insulate the bottom portion 41 and the first current collecting plate 140.

The side portion 42 may be formed to have a crimping portion 62 by a normal press processing. The crimping portion 62 may be a part where the opening side end of the side portion 42 is bent vertically toward the inside of the can 120. The edge of the cap plate 130 may be compressed between the beading portion 61 and the crimping portion 62 via a third insulator 163, and the cap plate 130 may be firmly affixed to the end of the side portion 42. The cap plate 130 may be insulated from the first electrode 10 and the second electrode 20, and may be electrically non-polar.

The second current collecting plate 150 may include a conductive part 151 in close contact with the inner surface of the beading portion 61. A plurality of conductive parts 151 may be provided along the edge of the second current collecting plate 150. The can 120 may be charged with the same polarity as the second electrode 20 by the conductive part 151 and function as a second terminal (a negative terminal).

A notch groove 131 may be positioned on the inner surface of the cap plate 130. The notch groove 131 may have a V-shaped cross-section and may have a circular arc shape on the bottom (when viewing a target object from above). The internal temperature of the rechargeable battery 100 may rise due to various causes such as a rapid charge and discharge, an external impact, and exposure to a high-temperature environment, and internal pressure may rise due to a gasification of the electrolyte solution, etc. When the internal pressure of the rechargeable battery 100 increases, the cap plate 130 is broken around the notch groove 131 and internal gas may be discharged.

Referring to FIG. 1 to FIG. 7, the thickness (T2+T3) of the tubular portion 60 of the can 120 may be smaller than the thickness of the bottom portion 41 of the can 120. The rechargeable battery 100, according to some embodiments, may increase the capacity of the electrode assembly 110 by slimming the tubular portion 60 of the can 120. In other words, the capacity of the first and second composite layers 12 and 22 may be increased as the thickness of the tubular portion 60 is reduced. Additionally, the rechargeable battery 100 of the present embodiment may prevent the deterioration of strength due to the slimming of the tubular portion 60 by using the reinforcing portion 50.

The thickness T1 of the bottom portion 41 of the main can 40 may be approximately 0.8 mm, and the thickness T2 of the side portion 42 of the main can 40 may be approximately 0.15 mm to 0.4 mm. The thickness T3 of the reinforcing portion 50 may be approximately 0.05 mm to 0.3 mm, and the thickness (T2+T3) of the tubular portion 60 including the side portion 42 and the reinforcing portion 50 may be approximately 0.2 mm to 0.7 mm. The following table shows examples of the thickness of the bottom portion 41, the side portion 42, the reinforcing portion 50, and the tubular portion 60, according to some embodiments.

TABLE 1

| | | | Reinforcing | |
|---|---|---|---|---|
| | Bottom portion | Side portion | portion | Tubular portion |
| | thickness | thickness | thickness | thickness |
| | (T1, mm) | (T2, mm) | (T3, mm) | (T2 + T3, mm) |
| 1 | 0.8 | 0.15 | 0.05 | 0.2 |
| 2 | 0.8 | 0.2 | 0.1 | 0.3 |
| 3 | 0.8 | 0.25 | 0.15 | 0.4 |
| 4 | 0.8 | 0.3 | 0.2 | 0.5 |
| 5 | 0.8 | 0.35 | 0.25 | 0.6 |
| 6 | 0.8 | 0.4 | 0.3 | 0.7 |

If the thickness T2 of the side portion 42 is less than 0.15 mm and the thickness T3 of the reinforcing portion 50 is less than 0.05 mm, the strength of the tubular portion 60 of the can 120 may be degraded and deformation of the tubular portion 60 may occur when a strong external force is applied. If the thickness T2 of the side portion 42 is greater than 0.4 mm and the thickness T3 of the reinforcing portion 50 is greater than 0.3 mm, the slimming effect of the tubular portion 60 is degraded, and it may be difficult to obtain relatively large capacities.

In the some embodiments of the rechargeable battery 100, the tubular portion 60 of the can 120 has the dual structure of the side portion 42 and the reinforcing portion 50, so that the deterioration of strength due to the slimming of the tubular portion 60 may be prevented, and the mechanical characteristics required for the can 120 may be satisfied. In some embodiments, the reinforcing portion 50 and the side portion 42 do not require separate junction processes such as welding or bonding, so the manufacturing process of the can 120 may be desirable.

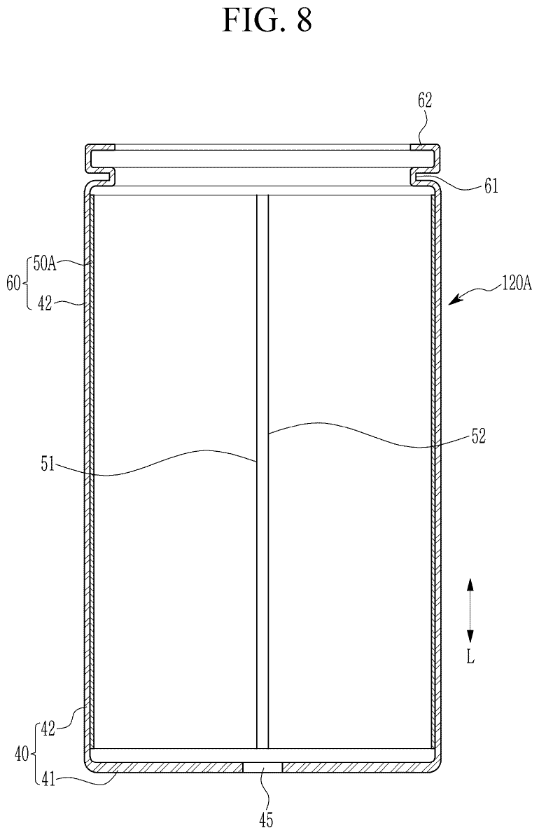

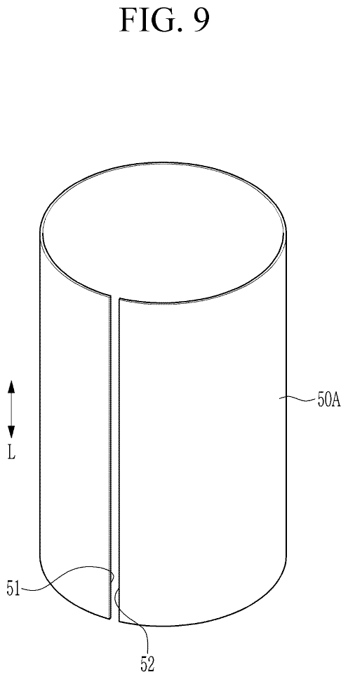

FIG. 8 is a cross-sectional view of a can of a rechargeable battery according to some embodiments. FIG. 9 is a perspective view of a reinforcing portion of a can shown in FIG. 8. The rechargeable battery of the second embodiment has the same or a similar configuration as the embodiments described above, except for the contents described below.

Referring to FIG. 8, the reinforcing portion 50A in the rechargeable battery of the present embodiment may be formed in a roughly (e.g., substantially) cylindrical shape with a first end 51 and a second end 52 spaced apart from each other. The reinforcing portion 50A may have a circular arc or a C-shape on a plane (when viewing a target object from above), and the first end 51 and the second end 52 may be parallel to the length direction (the direction L) of the can 120A. The reinforcing portion 50A has an open shape with the inside and outside communicating through an empty space between the first end 51 and the second end 52.

The reinforcing portion 50A may implement a predetermined elasticity along the circumferential direction. Since the reinforcing portion 50A may be transformed along the circumference direction by the empty space between the first end 51 and the second end 52, it may enter the inside of the main can 40 in a state where the distance between the first end 51 and the second end 52 is reduced, and after entering the inside of the main can 40, it may expand and come into close contact with the inside of the side portion 42. The reinforcing portion 50A, according to some embodiments, may provide relatively high adhesion with the side portion 42 than the reinforcing portion of the embodiments described above.

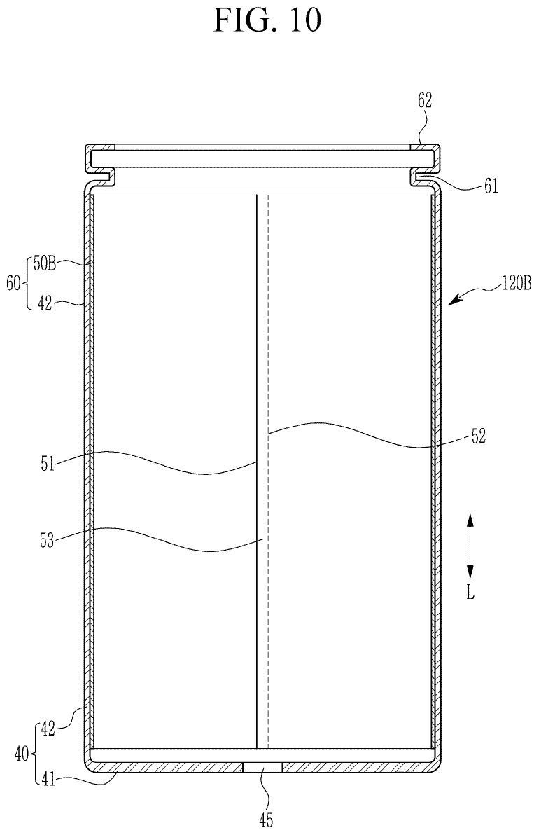

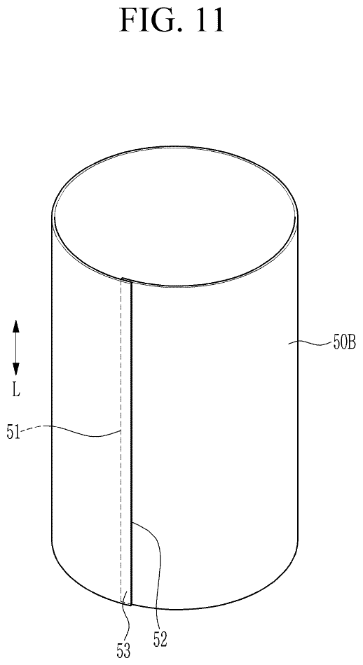

FIG. 10 is a cross-sectional view of a can of a rechargeable battery according to some embodiments. FIG. 11 is a perspective view of a reinforcing portion of a can shown in FIG. 10. The rechargeable battery of the third embodiment has the same or a similar configuration as the first embodiment described above, except for the contents described below.

Referring to FIG. 10 and FIG. 11, in the rechargeable battery of the present embodiment, a reinforcing portion 50B may be formed in a roughly (e.g., substantially) cylindrical shape with a first end 51, a second end 52, and an overlapping region 53 of a double sheet. The first end 51 and the second end 52 may be parallel to the length direction (the direction L) of a can 120B, and the reinforcing portion 50B may have a circumferential direction length exceeding 1 rotation from the first end 51. The part where the reinforcing portion 50B forms two sheets between the first end 51 and the second end 52 may be the overlapping region 53. The shape of the reinforcing portion 50B may be referred to as a type of a spiral.

The reinforcing portion 50B may implement a predetermined elasticity along the circumferential direction. In other words, the reinforcing portion 50B may be transformed along the circumferential direction so that the width of the overlapping region 53 changes. The reinforcing portion 50B may enter the inside of the main can 40 in a state in which the width of the overlapping region 53 is large, and after entering the inside of main can 40, it may be expanded to reduce the width of the overlapping region 53 and be in close contact with the inner surface of the side portion 42. The reinforcing portion 50B of the present embodiment may provide better adhesion with the side portion 42 than the reinforcing portion of some embodiments described above.

The reinforcing portions 50A and 50B described above may be pressed against the inner surface of the side portion 42 via the elasticity in the circumferential direction without being joined to the inner surface of the side portion 42 via welding and/or bonding.

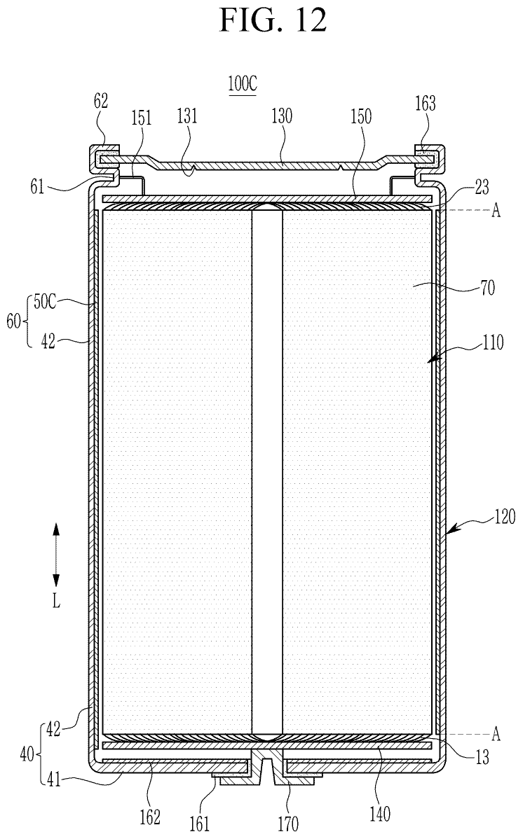

FIG. 12 is a cross-sectional view of a rechargeable battery according to some embodiments. The rechargeable battery, according to some embodiments, has the same or a similar configuration as any one of embodiments described above, except for the contents described below.

Referring to FIG. 3 and FIG. 12, in a rechargeable battery 100C of the present embodiment, a reinforcing portion 50C may be positioned to surround a central portion 70 of the electrode assembly 110 excluding the first uncoated region 13 and the second uncoated region 23 among the electrode assembly 110. That is, the height of the reinforcing portion 50C along the length direction (the direction L) of a can 120C may be less than the height of the electrode assembly 110, and may be equal to the height of the central portion 70 where the separator 30 of the electrode assembly 110 is positioned.

Since both sides (e.g., the upper and lower sides) of the electrode assembly 110 where the first and second uncoated regions 13 and 23 are positioned may be said to have mechanical strength secured by the first and second current collecting plates 140 and 150, the reinforcing portion 50C may be positioned to surround only the central portion 70 of the electrode assembly 110 where the separator 30 is positioned. In FIG. 12, the positions of both sides (e.g., the upper and lower sides) of the reinforcing portion are marked with a line A. The reinforcing portion 50C has the same basic shape as the reinforcing portion of any one of the above-described embodiments, except for the position and height within the side portion 42.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery comprising:
an electrode assembly;
a can that accommodates the electrode assembly in an interior space of the can; and
a cap plate that is coupled to an opening side end of the can and seals the can,
wherein the can includes:
a main can including a bottom portion having a first thickness and a side portion, having a second thickness less than the first thickness, connected to the edge of the bottom portion; and
a reinforcing portion positioned inside the side portion, the reinforcing portion having a third thickness less than the second thickness and a strength greater than a strength of the main can,
wherein the sum of the second thickness and the third thickness is less than the first thickness.

2. The rechargeable battery of claim 1, wherein:
the reinforcing portion is in the form of a cylinder, and
the exterior diameter of the reinforcing portion corresponds to a value of the interior diameter of the side portion plus a fitting allowance.

3. The rechargeable battery of claim 1, wherein:
the reinforcing portion is formed of an approximately cylindrical shape that implements an elasticity along a circumferential direction of the reinforcing portion, and is in close contact with the inner surface of the side portion.

4. The rechargeable battery of claim 3, wherein:
the reinforcing portion has a first end and a second end that are spaced apart from each other along the circumferential direction of the reinforcing portion and is formed in a circular arc or a “C” shape on a plane.

5. The rechargeable battery of claim 3, wherein:
the reinforcing portion includes a first end and a second end, and the reinforcing portion has a circumferential direction length exceeding 1 rotation from the first end to the second end such that the reinforcing portion overlaps between the first end and the second end.

6. The rechargeable battery of claim 1, wherein:
the side portion includes a beading portion recessed toward the interior of the can, and
the reinforcing portion is positioned between the bottom portion and the beading portion.

7. The rechargeable battery of claim 6, wherein:
the beading portion is connected to the side portion through a first curved portion of the beading portion,
the side portion is connected to the bottom portion through a second curved portion, and
the reinforcing portion is positioned between the first curved portion and the second curved portion.

8. The rechargeable battery of claim 6, wherein:
the electrode assembly includes a central portion where a first electrode, a separator, and a second electrode are stacked and wound, a first uncoated region positioned on one side of the central portion toward the bottom portion, and a second uncoated region positioned on the other side of the central portion toward the cap plate,
the height of the reinforcing portion is equal to the height of the central portion, and
the reinforcing portion is positioned to surround the central portion.

9. The rechargeable battery of claim 1, wherein:
the main can is formed of a steel plate cold deep-drawn extra (SPCE) for deep processing, and
the reinforcing portion is formed of stainless steel, steel plate cold commercial (SPCC), and/or high-strength steel.

10. The rechargeable battery of claim 1, wherein:
the second thickness is 0.15 mm to 0.4 mm, and
the third thickness is 0.05 mm to 0.3 mm.

11. A rechargeable battery comprising:
an electrode assembly;
a can that accommodates the electrode assembly in an interior space of the can; and
a cap plate that is coupled to an opening side end of the can and seals the can,
wherein the can includes:
a bottom portion made of a single material, and
a tubular portion connected to the edge of the bottom portion, the tubular portion having a thickness smaller than the thickness of the bottom portion and comprising an outer part and an inner part with different materials and thicknesses.

12. The rechargeable battery of claim 11, wherein:
the outer part is made of the same material as the bottom portion, and
the outer part and the bottom portion are integrally connected.

13. The rechargeable battery of claim 12, wherein:
the inner part is formed of a material with greater strength than the strength of the bottom portion and the outer part, and
the thickness of the inner part is smaller than the thickness of the outer part.

14. The rechargeable battery of claim 11, wherein:
the outer part includes a beading portion recessed toward the interior of the can, and
the inner part is positioned between the bottom portion and the beading portion.

15. The rechargeable battery of claim 14, wherein:
the inner part is in the form of a cylinder, and
the exterior diameter of the inner part corresponds to the value of the interior diameter of the outer part plus a fitting allowance.

16. The rechargeable battery of claim 14, wherein:
the inner part has a first end and a second end that are spaced apart from each other along the circumferential direction of the tubular portion, and is formed in a circular arc or a “C” shape on a plane.

17. The rechargeable battery of claim 14, wherein:
the inner part includes a first end and a second end, and the inner part has a circumferential direction length exceeding 1 rotation from the first end to the second end, such that the inner part overlaps between the first end and the second end.

18. A method for manufacturing a rechargeable battery, the method comprising:
positioning an electrode assembly in an interior space of a can, wherein:
a cap plate is coupled to an opening side end of the can;
the cap plate seals the can;
the can includes a bottom portion made of a single material; and
the can includes a tubular portion that is connected to the edge of the bottom portion, the tubular portion having a thickness smaller than the thickness of the bottom portion and comprising of an outer part and an inner part with different materials and thicknesses.

19. The method of claim 18, wherein:
the outer part is made of the same material as the bottom portion, and
the outer part and the bottom portion are integrally connected.

20. The method of claim 19, wherein:
the inner part is formed of a material with greater strength than the strength of the bottom portion and the outer part, and
the thickness of the inner part is smaller than the thickness of the outer part.
